(19) United States
(12) Patent Application Publication
(10) Pub. No.: US 2005/0241541 A1
(43) Pub. Date: Nov. 3, 2005

(54) Gypsum-based mortars using water retention agents prepared from raw cotton linters

(76) Inventors: Wilfried Hohn, Erfstadt (DE); Christian Morgenroth, Essen (DE); Dieter Schweizer, Duesseldorft (DE)

Correspondence Address: Hercules Incorporated;Hercules Plaza, 1313 North Market Street, Wilmington, DE, 19894-0001, US

(21) Appl. No.: 11/113,685

(22) Filed: Apr. 25, 2005

Related U.S. Application Data
(60) Provisional application No. 60/565,643, filed on Apr. 27, 2004.

(51) Int. Cl. C04B 14/00

(52) U.S. Cl. 106/805

(57) ABSTRACT

A mixture composition of a cellulose ether made from raw cotton linters and at least one additive is used in a gypsum based dry mortar composition wherein the amount of the cellulose ether in the gypsum based dry mortar composition is significantly reduced. When this gypsum based dry mortar composition is mixed with water and applied to a substrate, the water retention, sag resistance, and workability of the wet plaster mortar are comparable or improved as compared to when using conventional similar cellulose ethers.

This application claims the benefit of U.S. Provisional Application No. 60/565,643, filed Apr. 27, 2004.

### FIELD OF THE INVENTION

This invention relates to a mixture composition useful in dry gypsum-based mortar compositions for plastering walls, filling gaps or holes and fixing gypsum plasterboards onto walls. More specifically, this invention relates to a dry gypsum-based mortar using an improved water retention agent of a cellulose ether that is prepared from raw cotton linters.

### BACKGROUND OF THE INVENTION

Traditional gypsum-based mortars are often simple mixtures of gypsum (calcium sulfate anhydrite or hemihydrate) and aggregates, e.g., limestone. The dry mixture is mixed with water to form a plaster. These traditional plasters, per se, have poor workability, applicability or trowellability. Consequently, the application of these plasters is labor intensive, especially in summer months under hot weather conditions, because of the rapid evaporation or removal of water from the plaster, which results in inferior or poor workability and insufficient hydration of gypsum.

Gypsum based systems include several applications of plasters to substrates. Gypsum hand plaster (GHP) is a plaster that contains gypsum as a mineral binding agent and is used mainly for interior use; this plaster is applied by hand to substrates such as walls and ceilings. Gypsum based machine plaster (GMP) is a plaster of a multi-phase mixture of hemihydrate and anhydrite gypsum as a mineral binding agent. This plaster is used mainly for walls and ceilings for interior use and is applied with a plastering machine. Gypsum board adhesive is a gypsum-based mortar that is used to fasten gypsum boards to walls.

The physical characteristics of a hardened traditional plaster are strongly influenced by its hydration process, and thus, by the rate of water removal therefrom during the setting operation. Any influence, which affects these parameters by increasing the rate of water removal or by diminishing the water concentration in the plaster at the onset of the setting reaction, can cause a deterioration of the physical properties of the plaster. Many substrates to which the gypsum based plasters are applied, such as lime sandstone, cinderblock, wood or masonry, are porous and able to remove a significant amount of water from the plaster leading to the difficulties just mentioned.

To overcome, or to minimize, the above mentioned water-loss problems, the prior art discloses uses of cellulose ethers in mortar application as water retention agents for mitigating this problem. U.S. patent application Publication 2004/0258901 A1 discloses a gypsum plaster that uses a cellulose ether binder that has a preferred molecular weight between 12,000 and 30,000. U.S. patent application Publication 2003/0005861 A1 discloses a dry gypsum based mortar formulation modified with water-redispersible polymer powders for use in construction industry. The thickeners used in this formulation are polysaccharides such as cellulose ethers. European Patent 0774445 B1 discloses a lime containing gypsum based plaster composition that uses a combination of a nonionic cellulose ether and carboxymethylcellulose as the water retaining agent and thickener.

German publication 4,034,709 A1 discloses the use of raw cotton linters to prepare cellulose ethers as additives to cement based hydraulic mortars or concrete compositions.

Cellulose ethers (CEs) represent an important class of commercially important water-soluble polymers. These CEs are capable of increasing viscosity of aqueous media. This viscosifying ability of a CE is primarily controlled by its molecular weight, chemical substituents attached to it, and conformational characteristics of the polymer chain. CEs are used in many applications, such as construction, paints, food, personal care, pharmaceuticals, adhesives, detergents/cleaning products, oilfield, paper industry, ceramics, polymerization processes, leather industry, and textiles.

Methylcellulose (MC), methylhydroxyethylcellulose (MHEC), ethylhydroxyethylcellulose (EHEC), methylhydroxypropylcellulose (MHPC), hydroxyethylcellulose (HEC), and hydrophobically modified hydroxyethylcellulose (HMHEC) either alone or in combination thereof are CEs that are widely used for dry mortar formulations in the construction industry. By a dry mortar formulation is meant a blend of gypsum, cement, and/or lime as the inorganic binder used either alone or in combination with aggregates (e.g., silica and/or carbonate sand/powder), and additives.

For their use, these dry mortars are mixed with water and applied as wet materials. For the intended applications, water-soluble polymers that give high viscosity upon dissolution in water are required. By using MC, MHEC, MHPC, EHEC, HEC, and HMHEC or combinations thereof, desired plaster properties such as high water retention (and consequently a defined control of water content) are achieved. Additionally, an improved workability and satisfactory adhesion of the resulting material can be observed. Since an increase in CE solution viscosity results in improved water retention capability and adhesion, high molecular weight CEs are desirable in order to work more efficiently and cost effectively. In order to achieve high solution viscosity, the starting cellulose ether has to be selected carefully. Currently, by using purified cotton linters or high viscosity wood pulps, the highest 2 wt % aqueous solution viscosity that can be achieved for alkylhydroxyalkylcelluloses is about 70,000-80,000 mPas (as measured using a Brookfield RVT viscometer at 20° C. and 20 rpm, using spindle number 7).

A need still exists in the gypsum based dry mortar industry for having a water retention agent that can be used in a cost effective manner to improve the application and performance properties of gypsum based dry mortars. In order to assist in achieving this result, it would be preferred to provide a water retention agent that provides an aqueous Brookfield solution viscosity of preferably greater than about 80,000 mPas and still be cost effective for use as a thickener and/or water retention agent.

### SUMMARY OF THE INVENTION

The present invention relates to a mixture composition for use in gypsum-based dry mortars of a cellulose ether in an amount of 20 to 99.9 wt % of alkylhydroxyalkylcelluloses, hydroxyalkylcelluloses, and mixtures thereof, prepared from raw cotton linters, and at least one additive in an amount of 0.1 to 80 wt % of organic or inorganic thickening agents, anti-sag agents, air entraining agents, wetting agents, defoamers, superplasticizers, dispersants, calcium-complexing agents, retarders, accelerators, water repellants, redispersible is powders, biopolymers, and fibres; the mixture, when used in a gypsum-based dry mortars formulation and mixed with a sufficient amount of water, the formulation produces a plaster mortar that can be applied to substrates, wherein the amount of the mixture in the plaster mortar is significantly reduced while water retention, sag-resistance, and workability of the plaster mortar are comparable or improved as compared to when using conventional similar cellulose ethers.

The present invention also is directed to dry gypsum based mortar composition of gypsum, fine aggregate material, and a water-retaining agent of at least one cellulose ether prepared from raw cotton linters. The dry gypsum based mortar composition, when mixed with a sufficient amount of water, produces a plaster mortar which can be applied on substrates, wherein the amount of water-retaining agent in the plaster is significantly reduced while the water retention, sag resistance, and workability are maintained or improved as compared to when using conventional similar cellulose ethers.

### DETAILED DESCRIPTION OF THE INVENTION

It has been surprisingly found that certain cellulose ethers, particularly alkylhydroxyalkylcelluloses and hydroxyalkylcelluloses made from raw cotton linters (RCL) have unusually high solution viscosity relative to the viscosity of conventional, commercial cellulose ethers made from purified cotton linters or high viscosity wood pulps. The use of these cellulose ethers in gypsum based plaster compositions provide several advantages (i.e., lower cost in use and better application properties) and improved performance properties that were hitherto not possible to achieve using conventional cellulose ethers.

In accordance with this invention, cellulose ethers of alkylhydroxyalkylcelluloses and hydroxyalkylcelluloses are prepared from cut or uncut raw cotton linters. The alkyl group of the alkylhydroxyalkylcelluloses has 1 to 24 carbon atoms and the hydroxyalkyl group has 2 to 4 carbon atoms. Also, the hydroxyalkyl group of the hydroxyalkylcelluloses has 2 to 4 carbon atoms. These cellulose ethers provide unexpected and surprising benefits to the gypsum-based plasters. Because of the extremely high viscosity of the RCL-based CEs, efficient application performance in different gypsum based applications could be observed. Even at lower use level of the RCL based CEs as compared to currently used high viscosity commercial CEs, similar or improved application performance with respect to water retention and other wet plaster properties are achieved.

It could also be demonstrated that alkylhydroxyalkylcelluloses and hydroxyalkylcelluloses, such as methylhydroxyethylcelluloses, methylhydroxypropylcelluloses, hydroxyethylcelluloses, and hydrophobically modified hydroxyethylcelluloses, prepared from RCL give significant body and improved sag-resistance to plasters.

In accordance with the present invention, the mixture composition has an amount of the cellulose ether of 20 to 99.9 wt %, preferably 70 to 99.0 wt %.

The RCL based, water-soluble, nonionic CEs of the present invention include (as primary CEs), particularly, alkylhydroxyalkylcelluloses and hydroxyalkylcelluloses, made from raw cotton linters (RCL). Examples of such derivatives include methylhydroxyethylcelluloses (MHEC), methylhydroxypropylcelluloses (MHPC), ethylhydroxyethylcelluloses (EHEC), methylethylhydroxyethylcelluloses (MEHEC), hydrophobically modified ethylhydroxyethylcelluloses (HMEHEC), hydroxyethylcelluloses (HEC), and hydrophobically modified hydroxyethylcelluloses (HMHEC), and mixtures thereof. The hydrophobic substituent can have 1 to 25 carbon atoms. Depending on their chemical composition, they can have, where applicable, a methyl or ethyl degree of substitution (DS) of 0.5 to 2.5, a hydroxyalkyl molar substitution (HA-MS) of about 0.01 to 6, and a hydrophobic substituent molar substitution (HS-MS) of about 0.01 to 0.5 per anhydroglucose unit. More particularly, the present invention relates to the use of these water-soluble, nonionic CEs as efficient thickener and/or water retention agents in dry-mortar gypsum-based applications, such as in gypsum hand plasters, gypsum-based machine plasters, joint filler, and gypsum board adhesives. The terms “gypsum based system” and “gypsum based dry mortar composition” will be used interchangeably in this application to include all of the above mentioned applications.

In practicing the present invention, conventional CEs made from purified cotton linters and wood pulps (secondary CEs) can be used in combination with RCL based CEs. The preparation of various types of CEs from purified celluloses is known in the art. These secondary CEs can be used in combination with the primary RCL-CEs for practicing the present invention. These secondary CEs will be referred to in this application as conventional CEs because most of them are commercial products or known in the marketplace and/or literature.

Examples of the secondary CEs are methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

In accordance with the present invention, one preferred embodiment makes use of MHEC and MHPC having an aqueous Brookfield solution viscosity of greater than 80,000 mPas, preferably greater than 90,000 mPas, as measured on a Brookfield RVT viscometer at 20° C., 20 rpm, and a concentration of 2 wt % using a spindle number 7.

In accordance with the present invention, the mixture composition has an amount of at least one additive of between 0.1 and 80 wt %, preferably between 0.5 and 30 wt %. Examples of the at least one additive are organic or inorganic thickening agents and/or secondary water retention agents, anti-sag agents, air entraining agents, wetting agents, defoamers, superplasticizers, dispersants, calcium-complexing agents, retarders, accelerators, water repellants, biopolymers, and fibres. An example of the organic thickening agent is polysaccharides. Other examples of additives are calcium chelating agents,fruit acids, and surface active agents.

More specific examples of the additives are homo- or co-polymers of acrylamides. Examples of such polymers are of poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

Examples of the polysaccharide additives are starch ether, starch, guar, guar derivatives, dextran, chitin, chitosan, xylan, xanthan gum, welan gum, gellan gum, mannan, galactan, glucan, arabinoxylan, alginate, and cellulose fibres.

Other specific examples of the additives are gelatin, polyethylene gylcol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, fruit acids, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

The mixture compositions of this invention can be prepared by a wide variety of techniques known in the prior art. Examples include simple dry blending, spraying of solutions or melts onto dry materials, co-extrusion, or co-grinding.

In accordance with the present invention, the mixture composition when used in a dry gypsum based plaster formulation and mixed with a sufficient amount of water to produce a plaster mortar, the amount of the mixture, and consequently the cellulose ether, is significantly reduced. The reduction of the mixture or cellulose ether is at least 5%, preferably at least 10%. Even with such reductions in the CE, the water retention, sag-resistance, and workability of the wet plaster mortar are comparable or improved as compared to when using conventional similar cellulose ethers.

The mixture composition of the present invention can be marketed directly or indirectly to gypsum based plaster manufacturers who can use such mixtures directly into their manufacturing facilities. The mixture composition can also be tailored to meet various customers' needs.

The gypsum based plaster composition of the present invention has an amount of CE of from about 0.01 to 1.0 wt %. The amount of the at least one additive is from about 0.0001 to 10 wt %. These weight percentages are based on the total dry weight of all of the ingredients of the dry gypsum based plaster composition.

In accordance with the present invention, the gypsum-based dry mortar composition has the fine aggregate material, when present, in an amount of 0.001-80 wt %, preferably in the amount of 10-50 wt %. Examples of the fine aggregate material are silica sand, dolomite, limestone, lightweight aggregates (e.g. perlite, expanded polystyrene, hollow glass spheres, expanded vermiculite). By “fine” is meant that the aggregate materials that have particle sizes up to 3.0 mm, preferably 2.0 mm.

In accordance with the present invention, the gypsum, i.e., calcium sulfate anhydrite and/or calcium sulfate hemihydrate, is present in the amount of 20-99.95 wt %, and preferably in the amount of 30-80 wt % in the gypsum-based dry mortar composition.

In accordance with the present invention, the hydrated lime, i.e., calcium hydroxide, is present in the amount of 0-20 wt %, and preferably in the amount of 0.5-5 wt % in the gypsum-based dry mortar composition.

In accordance with a preferred embodiment of the invention, cellulose ethers are prepared according to U.S. patent application Ser. No. 10/822,926, filed Apr. 13, 2004, which is herein incorporated by reference. The starting material of this embodiment of the present invention is a mass of unpurified raw cotton linter fibres that has a bulk density of at least 8 grams per 100 ml. At least 50 wt % of the fibres in this mass have an average length that passes through a US sieve screen size number 10 (2 mm openings). This mass of unpurified raw cotton linters is prepared by obtaining a loose mass of first cut, second cut, third cut and/or mill run unpurified, natural, raw cotton linters or mixtures thereof containing at least 60% cellulose as measured by AOCS (American Oil Chemists' Society) Official Method Bb 3-47 and commuting the loose mass to a length wherein at least 50 wt % of the fibres pass through a US standard sieve size no. 10. The cellulose ether derivatives are prepared using the above-mentioned comminuted mass of raw cotton linter fibres as the starting material. The cut mass of raw cotton linters are first treated with a base in a slurry or high solids process at a cellulose concentration of greater than 9 wt % to form an activated cellulose slurry. Then, the activated cellulose slurry is reacted for a sufficient time and at a sufficient temperature with an etherifying agent or a mixture of etherifying agents to form the cellulose ether derivative, which is then recovered. The modification of the above process to prepare the various CEs of the present invention is well known in the art.

The CEs of this invention can also be prepared from uncut raw cotton linters that are obtained in bales of the RCL that are either first, second, third cut, and/or mill run from the manufacturer.

Raw cotton linters including compositions resulting from mechanical cleaning of raw cotton linters, which are substantially free of non-cellulosic foreign matter, such as field trash, debris, seed hulls, etc., can also be used to prepare cellulose ethers of the present invention. Mechanical cleaning techniques of raw cotton linters, including those involving beating, screening, and air separation techniques, are well known to those skilled in the art. Using a combination of mechanical beating techniques and air separation techniques fibers are separated from debris by taking advantages of the density difference between fibers and debris. A mixture of mechanically cleaned raw cotton linters and “as is” raw cotton linters can also be used to manufacture cellulose ethers.

When compared with the plasters prepared with conventional cellulose ethers as the water retention agent, the plasters of this invention provide improved water retention, sag-resistance, and workability, which are important parameters used widely in the art to characterize gypsum plasters.

According to European Norm EN 1015-8 water retention and/or water retentivity is “the ability of a fresh hydraulic mortar to retain its mixing water when exposed to substrate suction”. It can be measured according to the European Norm EN 459-2.

Sag-resistance is the ability of a vertically applied fresh mortar to keep its position on the wall, i.e. a good sag-resistance prevents the fresh mortar to flow down. For gypsum-based plasters it is often subjectively rated by the responsible craftsman.

According to European Norm EN 1015-9 workability is “the sum of the application properties of a mortar which give its suitability”. It includes parameters such as stickiness and lightness of the investigated plaster, which are typically subjectively rated (see Examples) by the craftsman.

A typical gypsum-based dry mortar might contain some or all of the following components:

TABLE A
Typical Prior Art Composition of
Gypsum-based dry-mortar Systems

| | Typical | |
|---|---|---|
| Component | amount | Examples |
| Gypsum | 20-99.95% | Calcium sulfate anhydrite (CaSO₄); |
| | | calcium sulfate hemihydrate |
| | | (CaSO₄.0.5H₂O) |
| Hydrated | 0-10% | |
| lime | | |
| Aggregate | 0-70% | Silica sand, dolomite, limestone, |
| | | lightweight aggregates (e.g. perlite, |
| | | expanded polystyrene, hollow glass |
| | | spheres, expanded vermiculite), rubber |
| | | crums, fly ash |
| Spray | 0-20% | Homo-, co-, or terpolymers based on |
| dried | | vinylacetate, maleic ester, ethylene, |
| resin | | styrene, butadiene, versatate, and/or |
| | | acrylic monomers |
| Retarder | 0-2% | Fruit acids, phosphates, phosphonates, |
| | | Ca-salt of N-polyoxymethylene |
| | | aminoacid, |
| Fibre | 0-2% | Cellulose fibre, polyamide fibre, |
| | | polypropylene fibre |
| Cellulose | 0.05-2% | Methylcellulose (MC), methylhydroxy- |
| ether | | ethylcellulose (MHEC), methylhydroxy- |
| | | propylcellulose (MHPC), ethylhydroxy- |
| | | ethylcellulose (EHEC), hydroxyethyl- |
| | | cellulose (HEC), hydrophobically |
| | | modified hydroxyethylcellulose (HMHEC) |
| Other | 0-2% | Polyacrylamide, starch ether, starch, |
| additives | | air entraining agent |

The invention is further illustrated by the following Examples. Parts and percentages are by weight, unless otherwise noted.

### EXAMPLE 1

Examples 1 to 3 show some of the chemical and physical properties of the polymers of the instant invention as compared to similar commercial polymers.

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt % and 2 wt %. When ascertaining the viscosity of the cellulose ether solution, the corresponding methylhydroxyalkylcellulose was used on a dry basis, i.e., the percentage moisture was compensated by a higher weight-in quantity. Viscosities of currently available, commercial methylhydroxyalkylcelluloses, which are based on purified cotton linters or high viscous wood pulps have maximum 2 wt % aqueous solution viscosity of about 70,000 to 80,000 mPas (measured using Brookfield RVT viscometer at 20° C. and 20 rpm, using a spindle no. 7).

In order to determine the viscosities, a Brookfield RVT rotation viscosimeter was used. All measurements at 2 wt % aqueous solutions were made in deionized water at 20° C. and 20 rpm, using a spindle no. 7.

Determination of Moisture

The moisture content of the sample was measured using a commercially available moisture balance at 105° C. The moisture content was the quotient from the weight loss and the starting weight, and is expressed in percent.

Determination of Surface Tension

The surface tensions of the aqueous cellulose ether solutions were measured at 20° C. and a concentration of 0.1 wt % using a Krüss Digital-Tensiometer K10. For determination of surface tension the so-called “Wilhelmy Plate Method” was used, where a thin plate is lowered to the surface of the liquid and the downward force directed to the plate is measured.

TABLE 1
Analytical Data

| | Methoxyl/ | | | | |
|---|---|---|---|---|---|
| | Hydroxyethoxyl | Viscosity on dry basis | | | Surface |
| | or Hydroxypropoxyl | at 2 wt % | At 1 wt % | Moisture | tension* |
| Sample | [%] | [mPas] | [mPas] | [%] | [mN/m] |
| RCL-MHPC | 26.6/2.9 | 95400 | 17450 | 2.33 | 35 |
| MHPC 65000 | 27.1/3.9 | 59800 | 7300 | 4.68 | 48 |
| (control) | | | | | |
| RCL-MHEC | 23.3/8.4 | 97000 | 21300 | 2.01 | 43 |
| MHEC 75000 | 22.6/8.2 | 67600 | 9050 | 2.49 | 53 |
| (control) | | | | | |

*0.1 wt % aqueous solution at 20° C.

Table 1 shows the analytical data of a methylhydroxyethylcellulose and a methylhydroxypropylcellulose derived from RCL. The results clearly indicate that these products have significantly higher viscosities than current, commercially available high viscous types. At a concentration of 2 wt %, viscosities of about 100,000 mPas were found. Because of their extremely high values, it was more reliable and easier to measure viscosities of 1 wt % aqueous solutions. At this concentration, commercially available high viscous methylhydroxyethylcelluloses and methylhydroxypropylcelluloses showed viscosities in the range of 7300 to about 9000 mPas (see Table 1). The measured values for the products based on raw cotton linters were significantly higher than the commercial materials. Moreover, it is clearly indicated by Table 1 that the cellulose ethers which are based on raw cotton linters have lower surface tensions than the reference samples.

### EXAMPLE 2

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt %. When ascertaining the viscosity of the cellulose ether solution, the corresponding hydroxyethylcellulose was used 5 on a dry basis, i.e., the percentage moisture was compensated by a higher weight-in quantity.

In order to determine the viscosities, a Brookfield LVF rotation viscometer was used. All measurements were made at 25° C. and 30 rpm, using spindle number 4.

Hydroxyethylcellulose made from purified as well as raw cotton linters were produced in Hercules' pilot plant reactor. As indicated in Table 2 both RCL based HEC and HEC made from purified cotton linters have about the same hydroxyethoxyl-content. But the solution viscosity of the RCL based is about 23% higher than that of the purified cotton linters based HEC.

TABLE 2
Analytical Data of HEC-samples

| | Hydroxyethoxyl [%] | at 1 wt % [mPas] |
|---|---|---|
| Purified cotton linters | 58.7 | 3670 |
| based HEC | | |
| RCL-HEC | 57.1 | 4530 |

### EXAMPLE 3

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 or 2 wt %. When ascertaining the viscosity of the cellulose ether solution, the corresponding hydrophobically modified hydroxyethylcellulose was used on a dry basis, i.e., the percentage moisture was compensated by a higher weight-in quantity.

In order to determine the viscosities, a Brookfield LVF rotation viscometer was used. All measurements were made at 25° C. and 30 rpm, using spindles numbers 3 and 4, respectively.

Hydrophobically modified hydroxyethylcelluloses (HMHEC) were made by grafting n-butyl glycidyl ether (n-BGE) onto the HEC. As indicated in Table 3 both samples have about the same substitution parameters. But solution viscosity of the RCL based HMHEC was significantly higher than that of the purified cotton linters based HMHEC.

TABLE 3
Analytical Data of HMHEC-samples

| | Viscosity | | | n-BGE (n-butyl- | |
|---|---|---|---|---|---|
| | [mPas] | | | glycidyl ether) | Moisture |
| | 1% | 2% | HE-MS | MS | [%] |
| RCL-HMHEC | 1560 | 15800 | 2.74 | 0.06 | 2.8 |
| Purified linters | 700 | 9400 | 2.82 | 0.09 | 1.3 |
| HMHEC | | | | | |

### EXAMPLE 4

All tests were conducted in a gypsum machine plaster basic-mixture comprising 57.4 wt % β-calcium sulfate hemihydrate, 30.0 wt % highly burned gypsum (anhydrite), 10.0 wt % calcium carbonate (particle sizes of 0.1-1.0 mm), 0.5 wt % hydrated lime, 0.1 wt % tartaric acid, and 2.0 wt % of perlite (particle sizes of 0.001-1.0 mm in diameter).

For quality assessment various test methods were applied. In order to have a better comparison for the different samples, water ratio for all trials was the same.

Determination of Spreading Value

The spreading value is determined according to European standard EN 13279-2 point 4.3.3. (Shock Table method). A cone with a height of 60 mm and a maximum diameter of 100 mm is placed on a Shock Table and filled with wet mortar. After replacement of the cone, the material is shocked. The spreading value is the diameter of the gypsum material after 15 shocks.

Determination of Water Retention

The wet mortar was mixed according to the European standard EN 13279-2. The water factor was fixed within an empirically developed and for plaster typical spreading value. The water retention was measured according to the European standard EN 459-2.

Methylhydroxyethylcellulose (MHEC) and methylhydroxypropylcellulose (MHPC) made from RCL were tested in the gypsum machine plaster basic-mixture in comparison to commercially available, high viscosity MHEC and MHPC (from Hercules) as the control samples. The results are shown in Tables 15 4 and 5.

TABLE 4
Testing of different MHECs in gypsum machine plaster (GMP)
application (23° C./50% relative air humidity)

| | MHEC | MHEC | RCL- |
|---|---|---|---|
| | 75000 | 75000 | MHEC |
| | GMP basic-mixture | | |
| CE-dosage on basic- | 0.23 | 0.20 | 0.20 |
| mixture [%] | | | |
| Water factor** | 0.62 | 0.62 | 0.62 |
| Water retention [%] | 96.6 | 96.2 | 98.3 |
| Spreading value [mm] | 166 | 168 | 163 |
| Sag-resistance | *** | **+ | *** |
| (subjective rating) | | | |
| Stickiness | **+ | *** | **+ |
| (subj. rating) | | | |
| Lightness | **+ | *** | *** |
| (subj. rating) | | | |

* corresponds to 1*; + corresponds to ½*; the more * the better the corresponding property
**Water factor amount of used water divided by amount of used dry mortar, e.g., 62 g of water on 100 g of dry mortar results in a water factor of 0.62.
n.d. = not determined

TABLE 5
Testing of different MHPCs in gypsum machine plaster (GMP)
application (23° C./50% relative air humidity)

| | MHPC | MHPC | RCL- |
|---|---|---|---|
| | 65000 | 65000 | MHPC |
| | GMP basic-mixture | | |
| CE-dosage on basic- | 0.23 | 0.20 | 0.20 |
| mixture [%] | | | |
| Water factor | 0.62 | 0.62 | 0.62 |
| Water retention [%] | 98.5 | 98.1 | 98.4 |
| Spreading value [mm] | 154 | 170 | 154 |
| Sag-resistance | *** | * | *** |
| (subjective rating) | | | |
| Stickiness | *** | *** | *** |
| (subj. rating) | | | |
| Lightness | * | ** | * |
| (subj. rating) | | | |

* corresponds to 1*; + corresponds to ½*; the more * the better the corresponding property
n.d. = not determined

Tables 5 and 6 clearly demonstrate that RCL-based products are more efficient than currently used high viscosity MHECs or MHPCs. When RCL-MHEC or RCL-MHPC were used at a 13% lower addition level as compared to the corresponding control samples, the resulting gypsum plaster had in case of lo RCL-MHPC similar, in case of RCL-MHEC even better water retention. The other wet mortar properties were comparable. When both the control and RCL-products were tested at a reduced addition level, the resulting RCL-CE containing plasters showed improved water retention as well as lower spreading values. The other properties were similar.

### EXAMPLE 5

The same gypsum machine plaster (GMP) basic-mixture as well as the determination of spreading value and water retention methods were used as in Example 4.

Methylhydroxyethylcellulose (MHEC) and methylhydroxypropylcellulose (MHPC) made from RCL were blended with polyacrylamide (PAA; molecular weight: 8-15 million g/mol; density: 700±50 g/dm³; anionic charge: 0-20 wt %) and tested in the gypsum machine plaster basic-mixture in comparison to 25 commercially available, high viscosity MHEC and MHPC (from Hercules) as the controls, which were modified accordingly. The results are shown in Tables 6 and 7.

TABLE 6
Testing of different modified MHECs in gypsum machine plaster
(GMP) application (23° C./50% relative air humidity)

| | MHEC | MHEC | RCL- |
|---|---|---|---|
| | 75000 + | 75000 + | MHEC + |
| | 3% PAA | 3% PAA | 3% PAA |
| | GMP basic-mixture | | |
| Dosage on basic- | 0.23 | 0.20 | 0.20 |
| mixture [%] | | | |
| Water factor | 0.70 | 0.70 | 0.70 |
| Water retention [%] | 95.0 | 93.6 | 96.0 |
| Spreading | 165 | 164 | 160 |
| value [mm] | | | |
| Sag-resistance | ***+ | ***+ | **** |
| (subjective rating) | | | |
| Stickiness | *** | *** | *** |
| (subj. rating) | | | |
| Lightness | *** | ***+ | *** |
| (subj. rating) | | | |

* corresponds to 1*; + corresponds to ½*; the more * the better the corresponding property
n.d. = not determined

TABLE 7
Testing of different modified MHPCs in gypsum machine plaster
(GMP) application (23° C./50% relative air humidity)

| | MHPC | MHPC | RCL- |
|---|---|---|---|
| | 65000 + | 65000 + | MHPC + |
| | 3% PAA | 3% PAA | 3% PAA |
| | GMP basic-mixture | | |
| Dosage on basic- | 0.23 | 0.20 | 0.20 |
| mixture [%] | | | |
| Water factor | 0.70 | 0.70 | 0.70 |
| Water retention [%] | 92.9 | 91.9 | 96.4 |
| Spreading value | 160 | 161 | 163 |
| [mm] | | | |
| Sag-resistance | **** | *** | *** |
| (subjective rating) | | | |
| Stickiness | ***+ | ***+ | *** |
| (subj. rating) | | | |
| Lightness | *+ | *+ | *+ |
| (subj. rating) | | | |

* corresponds to 1*; + corresponds to ½*; the more * the better the corresponding property
n.d. = not determined

The results shown in Tables 6 and 7 indicate that PAA-modified RCL-MHEC or MHPC IS more efficient than currently used high viscosity MHECs or MHPCs modified with PAA (the controls). Despite their lower dosage levels, addition of PAA-modified RCL-CEs resulted in higher water retention values of the resulting GMP than the values using the controls. Moreover, the modified RCL-MHEC showed a slightly stronger thickening effect than its control (MHEC75000), which is reflected in the lower spreading value. For the other wet mortar properties, no significant difference between the control and corresponding RCL-CE were noted.

### EXAMPLE 6

The same gypsum machine plaster (GMP) basic-mixture as well as the determination of spreading value and water retention methods were used as in Example 4.

Methylhydroxyethylcellulose (MHEC) and methylhydroxypropylcellulose (MHPC) made from RCL were blended with hydroxypropyl starch (HPS; hydroxypropoxyl-content: 10-35 wt %; bulk density: 350-550 g/dm³; moisture content as packed: max 8%; particle size (Alpine air sifter): max. 20% residue on 0.4 mm sieve; solution viscosity (at 10 wt %, Brookfield RVT, 20 rpm, 20° C.): 1500-3000 mpas) and tested in the gypsum machine plaster basic-mixture in comparison to commercially available, high viscosity MHEC and MHPC (from Hercules) as the control samples, which were modified accordingly. The results are shown in Tables 8 and 9.

TABLE 8
Testing of different modified MHECs in gypsum machine plaster
(GMP) application (23° C./50% relative air humidity)

| | MHEC 75000 + 15% | MHEC | RCL- |
|---|---|---|---|
| | HPS (hydroxypropyl | 75000 + | MHEC + |
| | starch) | 15% HPS | 15% HPS |
| | GMP basic-mixture | | |
| Dosage on basic- | 0.265 | 0.23 | 0.23 |
| mixture [%] | | | |
| Water factor | 0.65 | 0.65 | 0.65 |
| Water retention [%] | 97.5 | 96.3 | 98.5 |
| Spreading value | 160 | 162 | 160 |
| [mm] | | | |
| Sag-resistance | **** | *** | *** |
| (subjective rating) | | | |
| Stickiness | *** | *** | *** |
| (subj. rating) | | | |
| Lightness | *** | **** | **** |
| (subj. rating) | | | |

* corresponds to 1*; + corresponds to ½*; the more * the better the corresponding property
n.d. = not determined

TABLE 9
Testing of different modified MHPCs in gypsum machine plaster
(GMP) application (23° C./50% relative air humidity)

| | MHPC | MHPC | RCL- |
|---|---|---|---|
| | 65000 + | 65000 + | MHPC + |
| | 15% HPS | 15% HPS | 15% HPS |
| | GMP basic-mixture | | |
| Dosage on basic- | 0.265 | 0.23 | 0.23 |
| mixture [%] | | | |
| Water factor | 0.65 | 0.65 | 0.65 |
| Water retention [%] | 97.2 | 96.1 | 97.4 |
| Spreading value | 162 | 164 | 164 |
| [mm] | | | |
| Sag-resistance | ***+ | *** | *** |
| (subjective rating) | | | |
| Stickiness | ** | *** | ** |
| (subj. rating) | | | |
| Lightness | ** | **+ | ** |
| (subj. rating) | | | |

* corresponds to 1*; + corresponds to ½*; the more * the better the corresponding property
n.d. = not determined

The results shown in Tables 6 and 7 indicate that HPS-modified RCL-MHEC or MHPC are more efficient than their currently used high viscosity HPS-modified control samples. Despite their lower dosage levels, addition of HPS-modified RCL-CEs resulted in at least the same water retention values for the resulting GMP as for the control samples. For the other wet mortar properties, no significant difference between the control samples and the corresponding RCL-CE could be seen.

### EXAMPLE 7

The same gypsum machine plaster (GMP) basic-mixture as well as the determination of spreading value and water retention methods were used as in Example 4.

Hydroxyethylcellulose (HEC) and hydrophobically modified hydroxyethylcellulose (HMHEC) made from RCL were tested in the gypsum machine plaster basic-mixture in comparison to high viscosity HEC and HMHEC, respectively, which were made from purified cotton linters. The results are shown in Tables 10 and 11.

TABLE 10
Testing of different HECs in gypsum machine plaster (GMP)
application (23° C./50% relative air humidity)

| | HEC | HEC | RCL-HEC |
|---|---|---|---|
| | GMP basic-mixture | | |
| Dosage on basic-mixture [%] | 0.23 | 0.20 | 0.20 |
| Water factor | 0.60 | 0.60 | 0.60 |
| Water retention [%] | 97.7 | 97.4 | 98.1 |
| Spreading value [mm] | 152 | 158 | 152 |
| Sag-resistance (subjective rating) | ** | ** | ** |
| Stickiness (subj. rating) | **** | **** | **** |
| Lightness (subj. rating) | ** | *** | ** |

* corresponds to 1*; + corresponds to ½*; the more * the better the corresponding property
n.d. = not determined

TABLE 11
Testing of different HMHECs in gypsum machine plaster (GMP)
application (23° C./50% relative air humidity)

| | HMHEC | HMHEC | RCL-HMHEC |
|---|---|---|---|
| | GMP basic-mixture | | |
| Dosage on basic- | 0.23 | 0.20 | 0.20 |
| mixture [%] | | | |
| Water factor | 0.62 | 0.62 | 0.62 |
| Water retention [%] | 96.5 | 90.7 | 97.5 |
| (after 5 min of maturing time)¹ | | | |
| Spreading value [mm] | 152 | 170 | 152 |
| Sag-resistance (subjective rating) | ** | * | ** |
| Stickiness (subj. rating) | *** | *** | *** |
| Lightness (subj. rating) | ** | ** | ** |

* corresponds to 1*; + corresponds to ½*; the more * the better the corresponding property
n.d. = not determined
¹due to the slower dissolution behavior of all investigated HMHECs, wet-mortar samples were mixed, matured for 5 min, and mixed again for 15 sec before water retention was determined

The results show that both RCL-HEC as well as RCL-HMHEC can be used at a 13% reduced dosage level as compared to their control samples while showing slightly improved water retention and similar other wet mortar properties for the resulting plaster. When addition levels of the control samples were also reduced by 13%, inferior application performance with respect to water retention 20 and thickening (higher spreading value) in comparison to the RCL-CE containing plasters were observed.

### EXAMPLE 8

The same gypsum machine plaster (GMP) basic-mixture as well as the determination of spreading value and water retention methods were used as in Example 4.

Hydroxyethylcellulose (HEC) and hydrophobically modified hydroxyethylcellulose (HMHEC) made from RCL were blended with polyacrylamide (PAA; molecular weight: 8-15 million g/mol; density: 700±50 g/dm³; anionic charge: 0-20 wt %) and tested in the gypsum machine plaster lo basic-mixture in comparison to modified HEC and HMHEC, respectively, which were made from purified cotton linters as control samples. The results are shown in Tables 12 and 13.

TABLE 12
Testing of different modified HECs in gypsum machine plaster
(GMP) application (23° C./50% relative air humidity)

| | | | RCL- |
|---|---|---|---|
| | HEC + | HEC + | HEC + |
| | 3% PAA | 3% PAA | 3% PAA |
| | GMP basic-mixture | | |
| Dosage on basic- | 0.23 | 0.20 | 0.20 |
| mixture [%] | | | |
| Water factor | 0.70 | 0.70 | 0.70 |
| Water retention [%] | 93.9 | 91.1 | 93.6 |
| Spreading value | 162 | 164 | 168 |
| [mm] | | | |
| Sag-resistance | *** | **+ | ** |
| (subjective rating) | | | |
| Stickiness | *** | **+ | *** |
| (subj. rating) | | | |
| Lightness | ** | ** | *** |
| (subj. rating) | | | |

* corresponds to 1*; + corresponds to ½*; the more * the better the corresponding property
n.d. = not determined

TABLE 13
Testing of different modified HMHECs in gypsum machine plaster
(GMP) application (23° C./50% relative air humidity)

| | | | RCL- |
|---|---|---|---|
| | HMHEC + | HMHEC + | HMHEC + |
| | 3% PAA | 3% PAA | 3% PAA |
| | GMP basic-mixture | | |
| Dosage on basic- | 0.23 | 0.20 | 0.20 |
| mixture [%] | | | |
| Water factor | 0.70 | 0.70 | 0.70 |
| Water retention [%] | 89.3 | 87.2 | 89.1 |
| (after 5 min of | | | |
| maturing time) | | | |
| Spreading value [mm] | 161 | 161 | 163 |
| Sag-resistance | **** | **** | ***+ |
| (subjective rating) | | | |
| Stickiness | **** | ***+ | **** |
| (subj. rating) | | | |
| Lightness | ** | ** | ** |
| (subj. rating) | | | |

* corresponds to 1*; + corresponds to ½*; the more * the better the corresponding property
n.d. = not determined

The results show that both RCL-HEC as well as RCL-HMHEC can be used at a 13% reduced dosage as compared to their control samples while still showing about the same wet mortar properties. The only significant difference lo was a higher spreading value for the modified RCL-HEC in comparison to modified, “normal” HEC as control. When addition levels of the control samples were also reduced by 13%, inferior application performance with respect to water retention in comparison to the RCL-CE containing plasters was observed.

### EXAMPLE 9

All tests were conducted in a joint filler basic-mixture of 80.0 wt % of β-calcium sulfate hemihydrate and 20.0 wt % of calcium carbonate (particle size <0.2mm).

For quality assessment various test methods were applied. In order to have a better comparison for the different samples, water ratio for all trials was the same.

Spreading Value and Water Retention

For determination of spreading value and water retention, the same procedures as in Example 4 were used.

Different kinds of cellulose ethers based either on RCL or high viscosity cellulose types were tested in joint filler application. Because of the effects, which already have been demonstrated in Examples 4-8, application performance of all RCL-based CEs was tested at a reduced dosage level (0.51%) and compared with the performance of the corresponding control samples at “typical” (0.60 wt %) addition level.

TABLE 14
Testing of different CEs in joint filler (JF) application
(23° C./50% relative air humidity)

| JF basic-mixture + 0.1% | | CE- | Water | Spreading |
|---|---|---|---|---|
| citric acid + 0.03% PAA** + | Water | dosage | retention | value |
| one of the following CEs | factor | [%] | [%] | [mm] |
| MHEC 75000 | 0.7 | 0.60 | 99.5 | 152 |
| RCL-MHEC | 0.7 | 0.51 | 99.3 | 154 |
| MHPC 65000 | 0.7 | 0.60 | 99.7 | 165 |
| RCL-MHPC | 0.7 | 0.51 | 99.7 | 160 |
| HEC from purified linters | 0.7 | 0.60 | 99.3 | 170 |
| RCL-HEC | 0.7 | 0.51 | 99.2 | 165 |
| HMHEC from purified linters | 0.7 | 0.60 | 99.5* | 170 |
| RCL-HMHEC | 0.7 | 0.51 | 99.5* | 165 |

n.d. = not determined
*water retention was measured after an additional maturing time of 5 minutes
**see Example 5

Although all RCL-CEs were tested at a 15% lower dosage level, they, nevertheless, showed similar water retention values, but stronger thickening effects (lower spreading values) than the corresponding control samples.

### EXAMPLE 10

All tests were conducted in a gypsum plasterboard adhesive (GBA) basic-mixture of 80.0 wt % of β-calcium sulfate hemihydrate and 15.0 wt % of calcium carbonate having particle sizes up to 0.1 mm, and 5.0 wt % of limestone with particle sizes of 0.1-0.5 mm.

For quality assessment, various test methods were applied. In order to have a better comparison for the different samples, water ratio for all trials was the same.

Spreading Value and Water Retention

For determination of spreading value and water retention, the same methods as used in Example 4 were used in this Example.

Different kinds of cellulose ethers based either on RCL or high viscosity cellulose types were tested in gypsum plasterboard application. Because of the effects which have already been demonstrated in Examples 4-8, application performance of all RCL-based CEs was tested at a reduced dosage (0.51%) and compared with the performance of the corresponding the control samples at “normal” (0.60 wt %) addition level.

TABLE 15
Testing of different CEs in gypsum plasterboard adhesive
(GBA) application (23° C./50% relative air humidity)

| GBA basic-mixture + 0.1% | | CE- | Water | Spreading |
|---|---|---|---|---|
| citric acid + 0.03% PAA** + | Water | dosage | retention | value |
| one of the following CEs | factor | [%] | [%] | [mm] |
| MHEC 75000 | 0.7 | 0.60 | 99.5 | 153 |
| RCL-MHEC | 0.7 | 0.51 | 99.4 | 148 |
| MHPC 65000 | 0.7 | 0.60 | 99.6 | 145 |
| RCL-MHPC | 0.7 | 0.51 | 99.6 | 145 |
| NEC from purified linters | 0.7 | 0.60 | 99.5 | 155 |
| RCL-HEC | 0.7 | 0.51 | 99.6 | 153 |
| HMHEC from purified linters | 0.7 | 0.60 | 99.4* | 150 |
| RCL-hmHEC | 0.7 | 0.51 | 99.3* | 150 |

n.d. = not determined
*water retention was measured after an additional maturing time of 5 minutes
**see Example 5

Despite the facts that all RCL-MHPC, RCL-HEC, and RCL-HMHEC were tested at a 15% lower dosage, they showed similar application performance to the corresponding control cellulose ether samples. When compared to the control MHEC 75000, addition of RCL-MHEC resulted in a stronger thickening of the resulting GBA, while water retention, density and air content were the same.

Although the invention has been described with referenced to preferred embodiments, it is to be understood that variations and modifications in form and detail thereof may be made without departing from the spirit and scope of the claimed invention. Such variations and modifications are to be considered within the purview and scope of the claims appended hereto.

1. A mixture composition for use in gypsum-based dry mortars comprising
a) a cellulose ether in an amount of 20 to 99.9 wt % selected from the group consisting of alkylhydroxyalkyl celluloses, hydroxyalkyl celluloses, and mixtures thereof, prepared from raw cotton linters, and
b) at least one additive in an amount of 0.1 to 80 wt % selected from the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres,
wherein when the mixture is used in a gypsum-based dry mortars formulation and mixed with a sufficient amount of water, the formulation will produce a plasters mortar that can be applied to substrates, wherein the amount of the mixture in the plaster mortar is significantly reduced while water retention, sag-resistance, and workability of the plaster mortar are comparable or improved as compared to when using conventional similar cellulose ethers.

2. The mixture composition of claim 1 wherein the alkyl group of the alkylhydroxyalkyl cellulose has 1 to 24 carbon atoms, and the hydroxyalkyl group has 2 to 4 carbon atoms.

3. The mixture composition of claim 1 wherein the cellulose ether is selected from the group consisting of methylhydroxyethylcelluloses (MHEC), methylhydroxypropylcelluloses (MHPC), hydroxyethylcellulose (HEC), ethylhydroxyethylcelluloses (EHEC), methylethylhydroxyethylcelluloses (MEHEC), hydrophobically modified ethylhydroxyethylcelluloses (HMEHEC), hydrophobically modified hydroxyethylcelluloses (HMHEC) and mixtures thereof.

4. The mixture composition of claim 1, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

5. The mixture composition of claim 1, wherein the amount of the cellulose ether is 70 to 99 wt %.

6. The mixture composition of claim 1, wherein the amount of the additive is 0.5 to 30 wt %.

7. The mixture composition of claim 1, wherein the at least one additive is selected from the group consisting of polysaccharides.

8. The mixture composition of claim 7, wherein the polysaccharides are selected from the group consisting of starch ether, starch, guar/guar derivatives, dextran, chitin, chitosan, xylan, xanthan gum, welan gum, gellan gum, mannan, galactan, glucan, arabinoxylan, alginate, and cellulose fibres.

9. The mixture composition of claim 1, wherein the at least one additive is selected from the group consisting of homo- or co-polymers of acrylamide, gelatine, polyethylenegylcol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

10. The mixture composition of claim 1, wherein the at least one additive is selected from the group consisting of calcium chelating agents, fruit acids, and surface active agents.

11. The mixture composition of claim 1, wherein the significantly reduced amount of the mixture used in the gypsum based system is at least 5% reduction.

12. The mixture composition of claim 1, wherein the significantly reduced amount of the mixture used in the gypsum based system is at least 10% reduction.

13. The mixture composition of claim 4, wherein the mixture is MHEC and an additive selected from the group consisting of homo- or co-polymer of acrylamide, starch ether, and mixtures thereof.

14. The mixture composition of claim 13, wherein the polyacrylamide is a homo-/co-polymers of acrylamide selected from the group consisting of polyacrylamide, poly(acrylamide-co-sodium-acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

15. The mixture composition of claim 13, wherein the starch ether is selected from the group consisting of hydroxyalkylstarches where the alkyl has 1 to 4 carbon atoms, carboxymethylated starch ethers, and mixtures thereof.

16. The mixture composition of claim 4, wherein the mixture is MHPC and an additive selected from the group consisting of homo- or co-polymers of acrylamide, starch ether, and mixtures thereof.

17. The mixture composition of claim 4, wherein the mixture is HEC and an additive selected from the group consisting of homo- or co-polymers of acrylamide, starch ether, and mixtures thereof.

18. The mixture composition of claim 4, wherein the mixture is HMHEC and an additive selected from the group consisting of homo- or co-polymers of acrylamide, starch ether, and mixtures thereof.

19. A gypsum-based dry mortar composition comprising at least gypsum and a water-retaining agent of at least one cellulose ether prepared from raw cotton linters,
wherein the gypsum-based dry mortar, when mixed with a sufficient amount of water, produces a plaster that can be applied to substrates, wherein the amount of water-retaining agent in the plaster is significantly reduced while the water retention, sag-resistance, and workability are comparable or improved as compared to when using conventional similar cellulose ethers.

20. The gypsum based dry mortar composition of claim 19, wherein the at least one cellulose ether is selected from the group consisting of alkylhydroxyalkyl celluloses and hydroxyalkyl celluloses and mixtures thereof, prepared from raw cotton linters.

21. The gypsum based dry mortar composition of claim 20, wherein the alkyl group of the alkylhydroxyalkyl celluloses has 1 to 24 carbon atoms and the hydroxyalkyl group has 2 to 4 carbon atoms.

22. The gypsum based dry mortar composition of claim 19, wherein the at least one cellulose ether is selected from the group consisting of methylhydroxyethylcelluloses (MHEC), methylhydroxypropylcelluloses (MHPC), hydroxyethylcelluloses (HEC), methylethylhydroxyethylcelluloses (MEHEC), ethylhydroxyethylcelluloses (EHEC), hydrophobically modified ethylhydroxyethylcelluloses (HMEHEC), hydrophobically modified hydroxyethylcelluloses (HMHEC) and mixtures thereof.

23. The gypsum-based dry mortar composition of claim 22, wherein the cellulose ether, where applicable, has a methyl or ethyl degree of substitution of 0.5 to 2.5, hydroxyethyl or hydroxypropyl molar substitution (MS) of 0.01 to 6, and molar substitution (MS) of the hydrophobic substituents of 0.01-0.5 per anhydroglucose unit.

24. The gypsum based dry mortar composition of claim 19, wherein the gypsum based dry mortar composition also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

25. The gypsum-based dry mortar composition of claim 19, wherein the amount of cellulose ether is 0.05 to 2.0 wt %.

26. The gypsum-based dry mortar composition of claim 19 in combination with one or more additives selected from the group consisting of organic or inorganic thickening agents, anti-sag agents, air entraining agents, wefting agents, defoamers, superplasticizers, dispersants, calcium-complexing agents, retarders, accelerators, water repellants, redispersible powders, biopolymers, and fibres.

27. The gypsum-based dry mortar composition of claim 26, wherein the one or more additives are organic thickening agents selected from the group consisting of polysaccharides.

28. The gypsum-based dry mortar composition of claim 27, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

29. The gypsum-based dry mortar composition of claim 26, wherein the one or more additives are selected from the group consisting of homo- and co-polymers of acrylamide, gelatin, polyethylenegylcol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, fruit acids, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, poly vinyl alcohol, and homo-, co-, or terpolymers based on vinyl acetate, maleic ester, ethylene, styrene, butadiene, vinyl versatate, and acrylic monomers.

30. The gypsum-based dry mortar composition of claim 26, wherein the amount of additives is between 0.0001 and 25 wt %.

31. The gypsum-based dry mortar composition of claim 19, wherein a fine aggregate material is present.

32 The gypsum-based dry mortar composition of claim 31, wherein the fine aggregate material is selected from the group consisting of silica sand, dolomite, limestone, light weight aggregates, rubber crumbs, and fly ash.

33. The gypsum-based dry mortar composition of claim 32, wherein lightweight aggregates are selected from the group consisting of perlite, expanded polystyrene, hollow glass spheres, expanded vermiculite, and cork.

34. The gypsum-based dry mortar composition of claim 31, wherein the fine aggregate material is present in the amount of 0.001 to 80 wt %.

35. The gypsum-based dry mortar composition of claim 31, wherein the fine aggregate material is present in the amount of 10 to 50 wt %.

36. The gypsum-based dry mortar composition of claim 19, wherein the gypsum is present in the amount of 20 to 99.95 wt %.

37. The gypsum-based dry mortar composition of claim 19, wherein the gypsum is present in the amount of 30 to 80 wt %.

38. The gypsum-based dry mortar composition of claim 19 in combination with hydrated lime.

39. The gypsum-based dry mortar composition of claim 38, wherein the hydrated lime is present in the amount of 0.001 and 20 wt %.

40. The gypsum based dry mortar composition of claim 19, wherein the MHEC or MHPC has an aqueous solution Brookfield viscosity of greater than 80,000 mPas as measured on a Brookfield RVT viscometer at 2 wt %, 20° C., and 20 rpm, using a spindle no. 7.

41. The gypsum based dry mortar composition of claim 19, wherein the MHEC or MHPC has an aqueous Brookfield solution viscosity of greater than 90,000 mPas as measured on a Brookfield RVT viscometer at 2 wt %, 20° C. and 20 rpm, using a spindle no. 7.

42. The gypsum based dry mortar composition of claim 19, wherein the significantly reduced amount of the cellulose ether used in the gypsum based composition is at least 5% reduction.

43. The gypsum based dry mortar composition of claim 19, wherein the significantly reduced amount of the mixture used in the gypsum based composition is at least 10% reduction.
